(19) United States
(12) Patent Application Publication
(10) Pub. No.: US 2020/0314273 A1
(43) Pub. Date: Oct. 1, 2020

(54) IMAGE FORMING APPARATUS, IMAGE FORMING METHOD, AND SPECIFIC INFORMATION GIVING DEVICE

(71) Applicant: KYOCERA Document Solutions Inc., Osaka (JP)

(72) Inventor: Yasushi IMANISHI, Osaka-shi (JP)

(73) Assignee: KYOCERA Document Solutions Inc., Osaka (JP)

(21) Appl. No.: 16/832,541

(22) Filed: Mar. 27, 2020

(30) Foreign Application Priority Data
Mar. 28, 2019 (JP) 2019-063751

(51) Int. Cl. H04N 1/00; G06F 3/12

(52) U.S. Cl. CPC H04N 1/00639; G06F 3/1239; G06F 3/1206; G06F 3/1252

(57) ABSTRACT

An image forming apparatus includes an acquisition section, a dividing section, and a data generator. The acquisition section acquires image data on a cord image representing an identification code containing specific information. The dividing section divides the image data into first image data representing a first image and second image data representing a second image so that an image to be formed on a recording medium according to the code image is divided into the first image and the second image. The data generator generates printing data containing: the first image data on the first image to be formed on a first side or a second side of a recording medium; and the second image data on the second image to be formed on the second side or the first side of the recording medium.

### INCORPORATION BY REFERENCE

The present application claims priority under 35 U.S.C. § 119 to Japanese Patent Application No. 2019-063751, filed on Mar. 28, 2019. The contents of this application are incorporated herein by reference in their entirety.

### BACKGROUND

The present disclosure relates to an image forming apparatus, an image forming method, and a specific information giving device.

In order to use an expansion function in an image forming apparatus such as a multifunction peripheral, specific information such as license information may he acquired.

### SUMMARY

An image forming apparatus according to an aspect of the present disclosure includes an acquisition section, a dividing section, and a data generator. The acquisition section acquires image data on a cord image representing an identification code containing specific information. The dividing section divides the image data into first image data representing a first image and second image data representing a second image so that an image to be formed on a recording medium according to the code image is divided into the first image and the second image. The data generator generates printing data containing the first image data and the second image data.

An image forming method according to an aspect of the present disclosure includes acquiring image data on a code image representing an identification code containing specific information, dividing the image data into first image data represent a first image and second image data representing a second image so that an image to be formed on a recording medium according to the code image is divided into the first image and the second image, and generating printing data containing the first image data and the second image data.

A specific information giving device according to an aspect of the present disclosure includes a specifying section, a code generator, a dividing section, and a data generator. The specifying section specifies specific information. The code generator generates image data on a code image representing an identification code containing the specific information. The dividing section divides the image data into first image data representing a first image and second image data representing a second image so that an image to be formed on a recording medium according to the code image is divided into the first image and the second image. The data generator generates printing data containing the first image data and the second image data.

### BRIEF DESCRIPTION OF THE DRAWINGS

FIG. 1 is a schematic configuration diagram of an image forming apparatus according to embodiments of the present disclosure.

FIG. 2 is a configuration block diagram of an image forming apparatus according to a first embodiment.

FIG. 3 illustrates a first example about how to reproduce a normal code.

FIG. 4A illustrates a second example about how to reproduce the normal code.

FIG. 4B illustrates a third example about how to reproduce the normal code.

FIG. 5 illustrates a fourth example about how to reproduce the normal code.

FIG. 6 illustrates a fifth example about how to reproduce the normal code.

FIG. 7 is a flowchart illustrating how to perform an image forming process as an example in the first embodiment.

FIG. 8 is a schematic diagram of a specific information management system according to a second embodiment.

FIG. 9 is a configuration block diagram of a management server in the second embodiment.

### DETAILED DESCRIPTION

Embodiments of an image forming apparatus according to the present disclosure will hereinafter be described with reference to the accompanying drawings. Elements that are the same or equivalent are labelled with the same reference signs in the drawings and description thereof is not repeated.

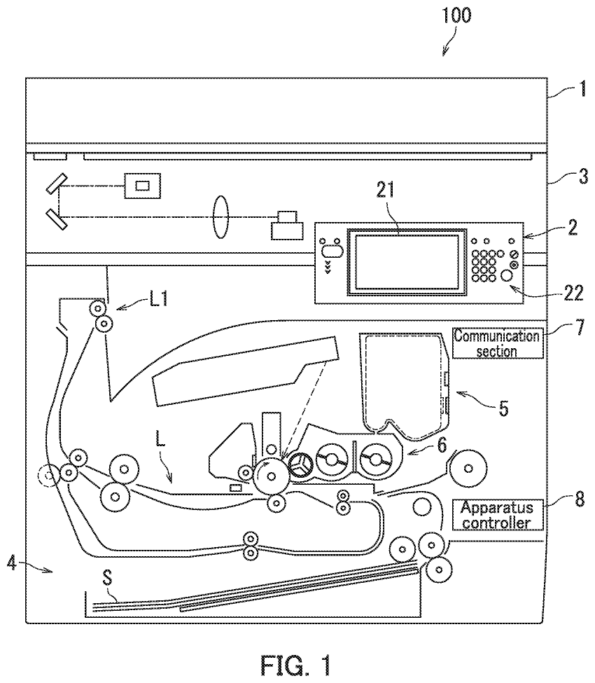

A configuration of an image forming apparatus 100 according to an embodiment of the present disclosure will be described with reference to FIG. 1. FIG. 1 is a schematic configuration diagram of the image forming apparatus 100. In the present disclosure, the image forming apparatus 100 is a monochrome multifunction peripheral.

The image forming apparatus 100 is able to reduce complexity when acquiring information on the right to use an expansion function while ensuring security of the information. The information is hereinafter referred to as “license information”. The image forming apparatus 100 includes a housing 1, an input/output section 2, a reading unit 3, a feed unit 4, a supply section 5, an image forming unit 6, a communication section 7, an apparatus controller 8, and a conveyance unit L. The reading unit 3, the feed unit 4, the supply section 5, the image forming unit 6, and the conveyance unit L are accommodated inside the housing 1. Note that the license information is one example of “specific information”. Here, the “specific information” is not limited to the license information. The “specific information” refers to information to be protected from unauthorized access.

In the present embodiment, the license information is provided by an identification code such as a two-dimensional code. Examples of the two-dimensional code include a QR CODE (registered Japanese trademark). Note that a type of the identification code to be provided as the license information is not limited to the two-dimensional code. The license information may be provided by for example a one-dimensional barcode. The license information may hereinafter be referred to simply as a “license”.

The input/output section 2 provides a user with various information. In addition, the input/output section 2 receives an instruction from the user. The input/output section 2 includes a display section 21 and a receiver section 22.

The display section 21 includes a display and displays thereon various information to be provided for the user. The display section 21 includes the display and a touch sensor.

The display displays various on-screen information. Examples of the on-screen information include an on-screen wallpaper. The on-screen wallpaper includes for example menu buttons enabling the user to enter instructions for performance of various processes. Examples of the display include a liquid-crystal display and an organic electro luminescence display.

The touch sensor detects a touch by an object. The touch sensor outputs a detection signal representing a location where the touch by the object has been detected. Examples of the object include a finger of the user. The touch sensor is for example a resistive touch sensor.

The receiver section 72 receives various instructions from the user. The receiver section 22 includes for example a numeric keypad, a start key, and a cancel key.

The reading unit 3 reads an image of a document. The reading unit 3 includes contact glass and a reading mechanism. The contact glass is located on an upper part of the reading unit 3. The contact glass allows the document to be placed thereon. The reading mechanism gives light to the document placed on the contact glass and reads the light reflected from the document to output a signal representing an image of the document. Further, the reading mechanism generates image data based on the signal representing the image of the document. The reading unit 3 is for example a scanner. Note that the reading unit 3 may read a sheet S on which a two-dimensional code is formed based on printing data and decode the two-dimensional code. Note that the reading unit 3 is one example of a “decoding section”.

The feed unit 4 accommodates sheets S and feeds the sheets S to the conveyance unit L one by one.

The conveyance unit L conveys the fed sheet S to an ejection section L1. The ejection section L1 ejects the sheet S on which a toner image has been fixed from an inside of the housing 1 to an exit tray via a sheet exit port.

The supply section 5 supplies toner to the image forming unit 6.

The image forming unit 6 forms an image (toner image) using the toner supplied from the supply section 5. Here, the image forming unit 6 includes a light exposure device, a charger, a photosensitive drum, a development device, a charger, a transfer device, and a fixing device. The image forming unit 6 electrographically forms an image. Note that the image forming unit 6 is one example of an “image forming section”.

Note that the image forming unit 6 may form an image on the sheet S based on the printing data generated by the apparatus controller 8.

The communication section 7 is configured to communicate with an electronic device(s using a communication method (protocol). The protocol of the electronic device is the same as that of the communication section 7. Here, the communication section 7 communicates with the electronic device via the Internet, a local area network (LAN), and the like. For example, the communication section 7 receives the printing data containing the license information from a management server that manages pieces of manufacturer license information. The printing data contains image data on a code image representing an identification code containing the specific information. The communication section 7 is for example a communication module such as a LAN board.

The communication section 7 receives the image data on the code image representing the identification code containing the specific information from the electronic device. Specifically, the communication section 7 receives image data on a code image representing a two-dimensional code containing license information from the management server that manages pieces of license information. Note that the communication section 7 is one example of an “acquisition section”.

The apparatus controller 8 controls respective operations of components of the image forming apparatus 100. Further, the apparatus controller 8 generates printing data based on the image data received through the communication section 7. The apparatus controller 8 includes for example a processor and memory. Examples of the processor include a central processing unit (CPU). The memory stores therein data and a computer program. Examples of the memory include semiconductor memory and a solid state drive (SSD).

### First Embodiment

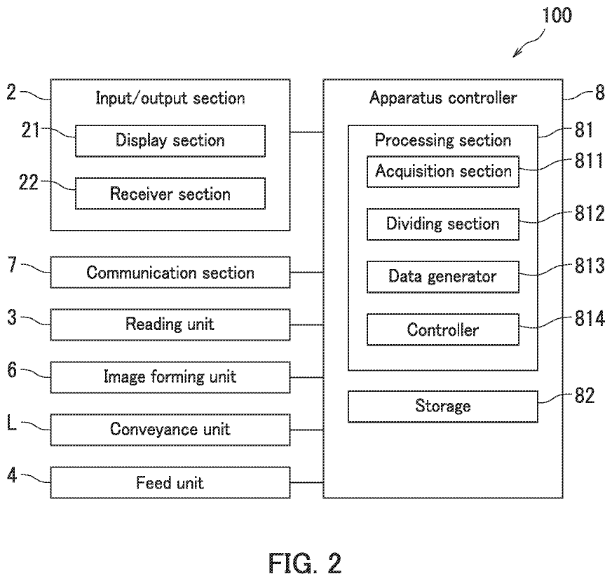

Of the configuration of the image forming apparatus 100, especially the configuration of the apparatus controller 8 will next be described in detail with reference to FIGS. 1 and 2. FIG. 2 is a configuration block diagram of the image forming apparatus 100.

As described with reference to FIG. 1, the image forming apparatus 100 includes the input/output section 2, the reading unit 3, the feed unit 4, the conveyance unit L, the image forming unit 6, the communication section 7, and the apparatus controller 8. FIG. 2 illustrates a detailed configuration of the apparatus controller 8.

As illustrated in FIG. 2, the apparatus controller 8 includes a processing section 81 and storage 82. The processing section 81 includes for example a processor. Examples of the processor include a CPU. The processing section 81 executes a control program stored in the storage 82, thereby controlling the respective operations of the components of the image forming apparatus 100.

The storage 82 stores therein various data and the control program. Examples of the storage 82 include read-only memory (ROM), random-access memory (RAM), and an SSD. The storage 82 may further include external memory. The external memory is for example removable media. Examples of the external memory that may be included in the storage 82 may further include universal serial bus (USB) memory and a secure digital (SD) card.

The storage 82 further stores therein the image data on the code image representing the identification code containing the specific information. Specifically, the storage 82 stores therein image data received from the management server that manages the pieces of license information. Here, the image data is data on a code image representing a two-dimensional code containing license information. Note that the storage 82 is another example of the “acquisition section”.

The processing section 81 includes an acquisition section 811, a dividing section 812, a data generator 813, and a controller 814. In the present embodiment, the storage 82 stores therein the control program which, when executed by the processing section 81, realizes respective functions of the acquisition section 811, the dividing section 812, the data generator 813, and the controller 814.

The acquisition section 811 acquires the image data on the cord image representing the identification code containing the specific information. Specifically, the acquisition section 811 acquires the image data on the code image representing the two-dimensional code containing the license information. In the present embodiment, the acquisition section 811 acquires the image data included in the printing data received through the communication section 7. The image data is data on the code image representing the two-dimensional code.

The dividing section 812 divides the image data into first image data representing a first image and the second image representing a second image so that an image to be formed on a recording medium according to the code image represented by the image data acquired by the acquisition section 811 is divided into the first image and the second image. Specifically, the dividing section 812 divides the image data into the first image data representing the first image and the second image representing the second image so that an image to be printed on the sheet S is formed by the first and second images. In the case where the code image representing the two-dimensional code is printed with the code image divided, a two-dimensional code formed by making the divided images adjacent to each other is hereinafter referred to as a “normal code”. In addition, in the case where the code image representing the two-dimensional code is printed with the code image divided, forming the two-dimensional code by making the divided images adjacent to each other is referred to as “synthesizing”.

Further, the dividing section 812 determines a support line representation corresponding to the divided first and second images. The dividing section 812 also determines the number of dummy codes and respective locations of the dummy codes. Specifically, the dividing section 812 determines the number of dummy codes and the respective locations of the dummy codes based on a number and a placement rule that are defined in advance.

The data generator 813 generates the printing data containing the first image data and the second image data divided by the dividing section 812. Specifically, the data generator 813 generates printing data that contains the first image data representing the first image to be formed on a first side or a second side of a recording medium and the second image data representing the second image to be formed on the second side or the first side of the recording medium. In the present embodiment, the data generator 813 generates printing data that contains the first image data representing the first image to be formed on a front surface or a back surface of the sheet S and the second image data representing the second image to be formed on the back surface or the first side of the sheet S.

Note that the printing data may contain support line representation data on the support line representation giving support for making the first and second images adjacent to each other. The data generator 813 may generate printing data containing the support line representation data.

For example, the printing data may contain reference line data on a reference line representing a location where the first and second images are allowed to be made adjacent to each other along the reference line, and fold line data on a fold line representing a location where the recording medium is allowed to be folded along the fold line. The data generator 813 may generate printing data containing the reference line data and the fold line data.

The printing data may contain fold-back line data on a fold-back line representing a location where the recording medium is allowed to be folded back along the fold-hack line. The data generator 813 may generate printing data containing the fold-back line data. Note that the support line representation includes at least one of limes that include the reference line, the fold line, and the fold-back line.

The printing data may contain dummy image data on a dummy cord giving support for making the first and second images adjacent to each other, or on a dummy code obstructing the support for making the first and second images adjacent to each other. The data generator 813 may generate printing data containing the dummy image data. A value obtained by decoding the dummy code may represent at least one of lines that include the reference line, the fold line, and the fold-back line. Note that a method of representing the reference line, the fold line, and the fold-back line giving the support for making the first and second images adjacent is not limited to the method using the dummy code. Only a specific user may be notified by an additional communication means.

The controller 814 controls the respective operations of the components of the image forming apparatus 100. Specifically, the controller 814 controls the communication section 7 and the storage 82. In the present embodiment, the controller 814 stores the printing data generated by the data generator 813 in the storage 82.

The controller 814 controls the image forming unit 6 so that the first image is formed on the first side or the second side of the recording medium based on the first image data and the second image is formed on the second side or the first side of the recording medium based on the second image data.

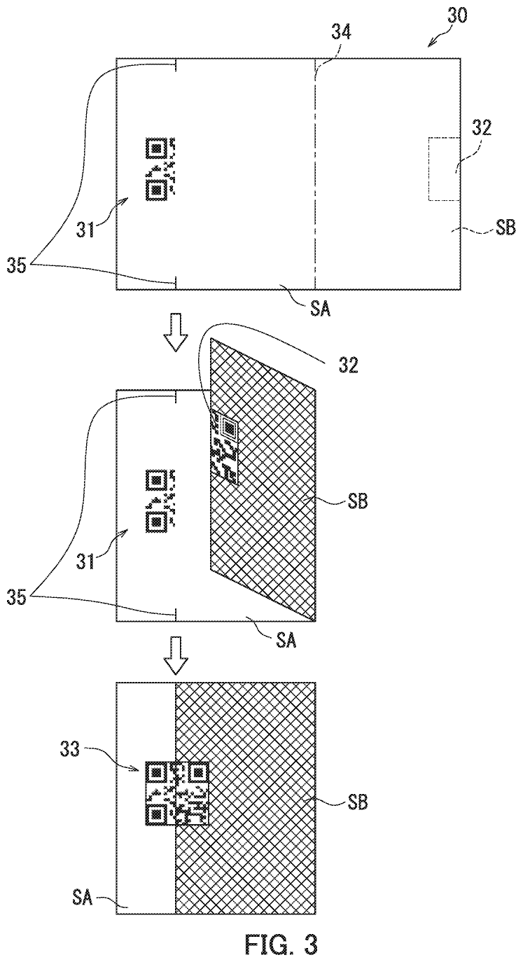

A method of reproducing the normal code will next be described with reference to FIGS. 3 to 6. FIG. 3 illustrates a first example about how to reproduce the normal code. As illustrated in FIG. 3, a sheet 30 has a front surface SA and a back surface SB. A partial code 31, a support line segment 34, and support line segments 35 are formed on the front surface SA of the sheet 30. A partial code 32 is formed on the hack surface SB of the sheet 30. In FIGS. 3 to 5, the partial code 32 is formed on the surface SB that is different from the surface SA on which the partial code 31 is formed. Note that the partial code 31 is one example of a “first image”, and the partial code 32 is one example of a “second image”.

The partial code 31 represents one part of the two-dimensional code obtained by coding the license information. The partial code 31 of the two-dimensional code is formed on a left side of the front surface SA of the sheet 30. The support line segment 34 is formed on a center of the front surface SA of the sheet 30. The support line segment 34 represents a location where the sheet 30 is allowed to be folded therealong. Specifically, the support line segment 34 represents the location where the sheet 30 is allowed to be folded along the support segment line 34 with the front surface SA inside. The support line segments 35 are formed above and below the left side of the front surface SA of the sheet 30. The support line segments 35 constitute a reference line serving as a reference location where the partial code 32 is allowed to be matched with the partial code 31 along the support lines 35.

As illustrated in FIG. 3, the partial code 32 is formed on the back surface SB of the sheet 30. The partial code 32 represents another part of the two-dimensional code obtained by coding the license information. The sheet 30 is folded along the support line segment 34 so that the partial code 32 on the back surface SB of the sheet 30 is matched with the partial code 31 on the front surface SA. As a result, the normal code 33 is reproduced. Note that the front surface SA is one example of the “first side” and the back surface SB is one example of the “second side”. In addition, the support line segment 34 is one example of the “reference line”.

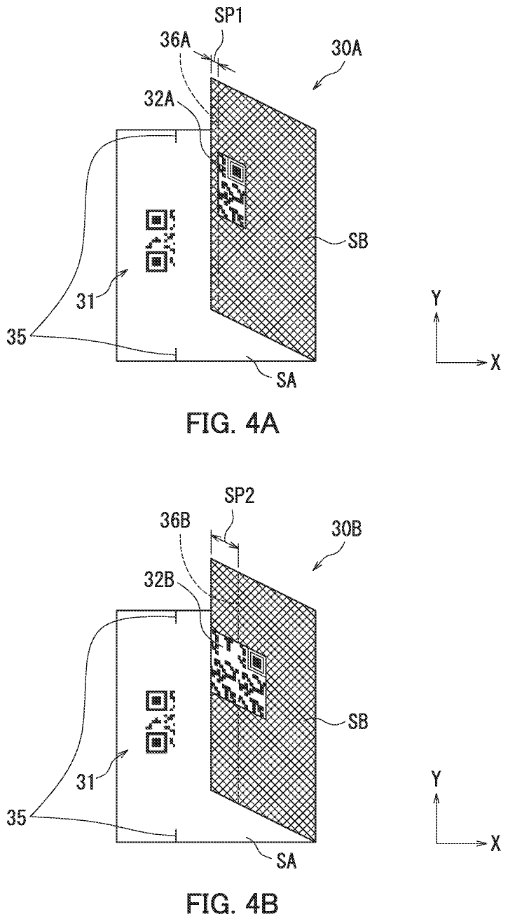

FIG. 4A illustrates a second example about how to reproduce the normal code. As illustrated in FIG. 4A, a sheet 30A has a front surface SA and a back surface SB. A partial code 31 and support line segments 35 are formed on the front surface SA of the sheet 30A. A partial code 32A and a support line segment 36A are formed on the back surface SB of the sheet 30A. Here, the partial code 32 is formed on the surface SB that is different from the surface SA on which the partial code 31 is formed. Note that a support line segment 34 is not depicted in FIG. 4A.

The partial code 32A represents one part of the two-dimensional code obtained by coding the license information. That is, in the present embodiment, the partial code 32A is the same image as the partial code 32 has. The partial code 32A is however different in location from the partial code 32. In the present embodiment, a blank area having a width SP1 in an X-direction is provided between the partial code 32A and an end of the back surface SB of the sheet 30A. The support line segment 36A represents a location where a right end of the sheet 30A is allowed to be further folded inside along the support line segment 36A. Note that the support line segment 36A is another example of the “fold line”.

As illustrated in FIG. 4A, by further folding the sheet 30A inside along the support line segment 36A, the partial code 32A on the back surface SB of the sheet 30A is matched with the partial code 31 on the front surface SA. As a result, the normal code 33 is reproduced.

FIG. 4B illustrates a third example about how to reproduce the normal code. As illustrated in FIG. 4B, a sheet 30B has a front surface SA and a back surface SB. A partial code 31 and support line segments 35 are formed on the front surface SA of the sheet 30B. A dummy-image-added partial code 32B and a support line segment 36B are formed on the back surface SB of the sheet 30B. The dummy-image-added partial code 32B includes a partial code 32A and a dummy image. In the present embodiment, of the dummy-image-added partial code 32B, a width of the dummy image in the X-direction is a width SP2. Note that a support line segment 34 is not depicted in FIG. 4B.

The dummy-image-added partial code 32B is a dummy of the two-dimensional code. In the present embodiment, the dummy-image-added partial code 32B is formed on the hack surface SB of the sheet 30B. The dummy-image-added partial code 32B is a dummy code that is a two-dimensional code and pseudo license information. The support line segment 36B represents a location where a right end of the sheet 30B is allowed to be further folded inside along the support line segment 36B. Note that the support line segment 36B is still another example of the “fold line”.

As illustrated in FIG. 4B, by further folding the sheet 30B inside along the support line segment 36B, the dummy-image-added partial code 32B on the hack surface SB of the sheet 30B is matched with the partial code 31 on the front surface SA. As a result, the normal code 33 is reproduced.

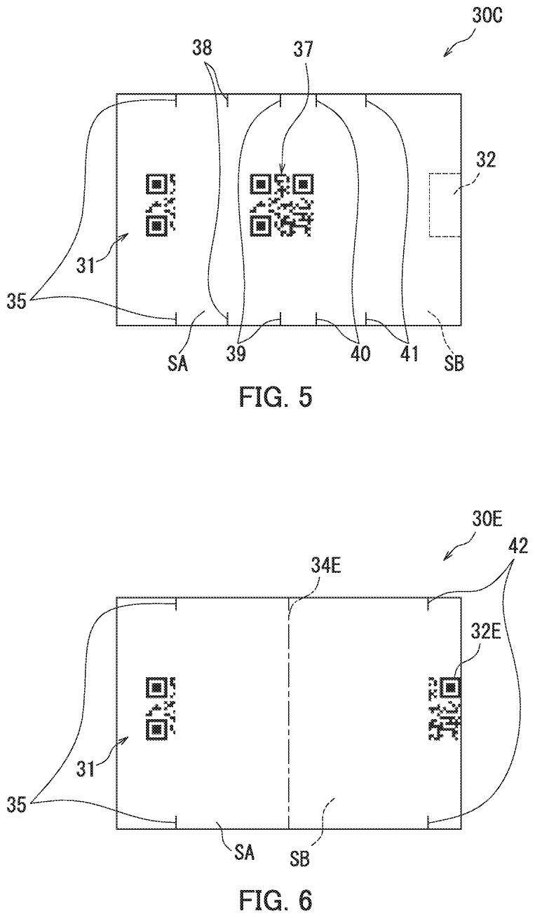

FIG. 5 illustrates a fourth example about how to reproduce the normal code. As illustrated in FIG. 5, a sheet 30C has a front surface SA and a back surface SB. A partial code 31, a dummy code 37, support line segments 35, support line segments 38, support line segments 39, support line segments 40, and support line segments 41 are formed on the front surface SA of the sheet 30C. A partial code 32 is formed on the back surface SB of the sheet 30C. Here, the partial code 32 is formed on the surface SB that is different from the surface SA on which the partial code 31 is formed.

The dummy code 37 is a pseudo two-dimensional code added to strengthen security. A specific value is obtained by decoding the dummy code 37. The value represents a location of support line segments giving support for reproduction of the normal code. Specifically, the partial code 32 is matched with the partial code 31 by folding or folding back the sheet 30C along the support line segments corresponding to the value obtained by decoding the dummy code 37. As a result, the normal code 33 is reproduced. For example, when the value obtained by decoding the dummy code 37 is “3”, the value represents, of five pairs of the support line segments formed on the front surface SA of the sheet 30C, a location of the support line segments 39.

FIG. 6 illustrates a fifth example about how to reproduce the normal code. FIG. 6 illustrates a sheet 30E on which images associated with the license information are formed. The sheet F has a front surface SA and a hack surface SB. As illustrated in FIG. 6, a partial code 31, a support line segment 34E, support line segments 35, a partial code 32E, and support line segments 42 are formed on the front surface SA of the sheet 30E. Here, the partial code 32 is formed on the surface SA that is the same as the surface SA on which the partial code 31 is formed.

The partial code 32E represents one part of the two-dimensional code obtained by coding the license information. That is, in the present embodiment, the partial code 32E is the same image as the partial code 32 has. The partial code 32E however differs from the partial code 32 formed on the back surface SB of the sheet 30 in that the partial code 32E is formed on the front surface SA of the sheet 30E. The support line segment 34E represents a location where the sheet 30E is allowed to be folded inside along the support line segment 34E. The support line segments 42 represent a location where the sheet 30E is allowed to be folded back outside along the support lines 42. Note that the support line segment 34E is still another example of the “reference line”. In addition, the support line segment 42 is one example of a “fold-back line”.

As illustrated in FIG. 6, by folding the sheet 30E inside along the support line segment 34E and further folding a right end of the sheet 30E outside along the support line segments 42, the partial code 32E on the front surface SA of the sheet 30E is matched with the partial code 31 on the front surface SA. As a result, the normal code 33 is reproduced.

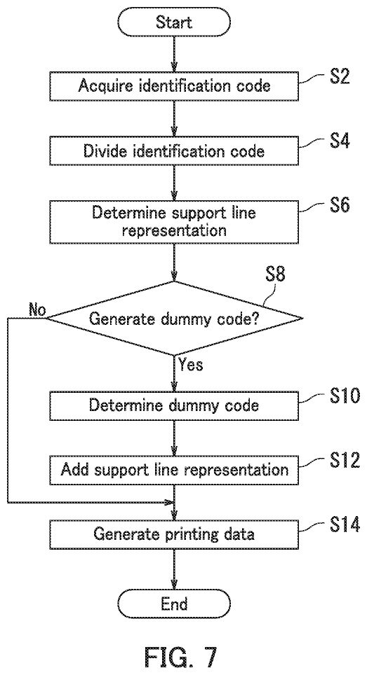

A process of acquiring the specific information in the present embodiment will next be described with reference to FIGS. 1 to 7. FIG. 7 is a flowchart illustrating how the image forming apparatus 100 performs an image forming process as an example. The image forming process is performed through Steps S2 to S14.

Step S2: the acquisition section 811 acquires the image data on the cord image representing the identification code containing the specific information. The process then proceeds to Step S4.

Step S4: the dividing section 812 divides the image data into the first image data representing the first image and the second image data representing the second image so that an image to be formed on the sheet S according to the code image represented by the image data acquired by the acquisition section 811 is divided into the first image and the second image. The process then proceeds to Step S6.

Step S6: the dividing section 812 determines a support line representation corresponding to the divided first and second images. The process then proceeds to Step S8.

Step S8: the controller 814 determines whether or not to generate a dummy code based on a user instruction. When the controller 814 determines to generate the dummy code (Yes at Step S8), the process proceeds to Step S10. When the controller 814 determines not to generate the dummy code (No at Step S8), the process proceeds to Step S14.

Step S10: the dividing section 812 determines the dummy code. Specifically, the dividing section 812 determines the number of dummy codes and respective locations of the dummy codes. The process then proceeds to Step S12.

Step S12: the dividing section 812 determines, according to the number of dummy codes and the respective locations of the dummy codes, respective corresponding support line segments. The process then proceeds to Step S14.

Step S14: the data generator 813 generates printing data containing: image data on the partial codes each of which is to be formed on the front surface or the back surface of the sheet S; and support line representation data on the support line representation, each element of which is to be formed on the front surface or the back surface of the sheets S. The process then ends.

A simple method as described with reference to FIGS. 1 to 7 enables the image forming apparatus 100 to acquire the specific information while ensuring security of the specific information. That is, the configuration allows only a specific user to be notified of how to reproduce the identification code by dividing the identification code representing the specific information into the first and second images to be formed on the recording medium. It is therefore possible to acquire by the simple method the specific information with the security of the specific information ensured.

### Second Embodiment

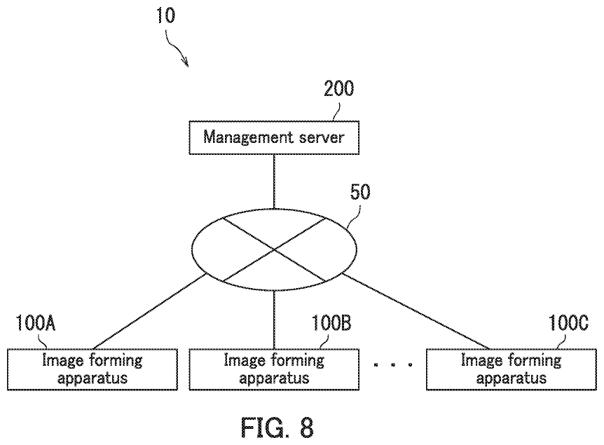

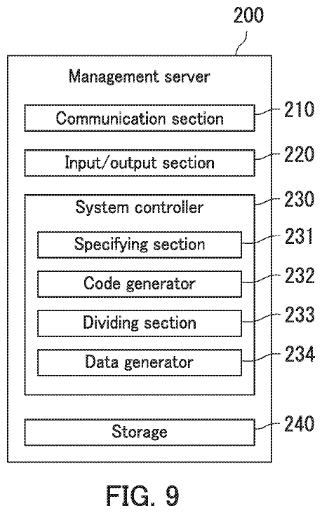

A specific information management system 10 according to a second embodiment will next be described with reference to FIGS. 8 and 9. FIG. 8 is a schematic diagram of the specific information management system 10. A management server 200 manages specific information provision. The specific information management system 10 includes the management server 200 and image forming apparatuses 100 including an image forming apparatus 100A, an image forming apparatus 100B, . . . , and an image forming apparatus 100C. The management server 200 gives specific information to each of the image forming apparatuses 100. Note that the image forming apparatus 100A, the image forming apparatus 100B, . . . , and the image forming apparatus 100C are collectively referred to as an image forming apparatus(es) 100.

FIG. 9 is a configuration block diagram of the management server 200. Like the described image forming apparatus 100 illustrated in FIG. 1, the management server 200 allows a specific user to be notified of how to reproduce an identification code by dividing the identification code representing specific information into first and second images to be formed on a recording medium.

A configuration of the management server 200 will next be described with reference to FIG. 9. FIG. 9 is a configuration block diagram of the management server 200. The management server 200 includes a communication section 210, an input/output section 220, a system controller, and storage 240.

The communication section 210 transmits and receives various information to and from each of the image forming apparatuses 100 like that described with reference to FIG. 1. The communication section 210 is an interface. According to an instruction of the system controller 230, the communication section 210 transmits printing data on an identification code representing corresponding license information to an image forming apparatus 100.

The input/output section 220 provides an administrator with various information. In addition, the input/output section 220 receives from the administrator an instruction to transmit printing data to the image forming apparatus 100. The input/output section 220 is for example a liquid-crystal display with a touch panel.

The system controller 230 is for example a microcomputer. The system controller 230 executes a control program stored in the storage 240, thereby controlling respective operations of components of the management server 200. The system controller 230 includes for example a processor and memory. Examples of the processor include a CPU. The memory stores therein data and a computer program. Examples of the memory include semiconductor memory and an SSD. The system controller 230 includes a specifying section 231, a code generator 232, a dividing section 233, and a data generator 234.

The specifying section 231 specifies the specific information. Specifically, the specifying section 231 specifies license information to be given to a corresponding image forming apparatus 100.

The code generator 232 generates a normal code. Specifically, the code generator 232 generates image data on a two-dimensional code based on the specified license information.

The dividing section 233 divides the image data into first image data representing a first image and second image data representing a second image so that an image to be formed on the recording medium according to a code image is divided into the first and second images. Note that the dividing section 233 has a function similar to that of the dividing section 812.

The data generator 234 generates printing data containing: the first image data on the first image to be formed on a first side or a second side of the recording medium; and the second image data on the second image to be formed on the second side or the first side of the recording medium. Note that the data generator 234 has a function similar to that of the data generator 813.

The storage 240 stores therein the control program and various data on the operation of the management server 200. The storage 240 may include at least one of devices that include ROM, RAM, an HDD, and an SSD.

A simple method as described with reference to FIGS. 8 to 9 enables the management server 200 to provide the specific information while ensuring security of the specific information. That is, the printing data is generated so that the identification code representing the specific information is divided into the first and second images to be formed on the recording medium. Further, the configuration allows only a specific user to be notified of how to reproduce the identification code. It is therefore possible to provide by the simple method the specific information with the security of the specific information ensured.

The embodiments of the present disclosure have been described above with reference to the drawings (FIGS. 1 to 9). However, the present disclosure is not limited to the above embodiments and may be implemented in various different forms that do not deviate from the essence of the present disclosure (for example, (1) to (3) described below). The drawings schematically illustrate elements of configuration in order to facilitate understanding, and properties such as thickness, length, and numbers of elements of configuration illustrated in the drawings may differ from actual properties thereof in order to facilitate preparation of the drawings. Further, the material, shape, or dimensions of each element described in the above embodiment is merely an example that does not impose any particular limitations and may be altered in various ways as long as such alterations do not substantially deviate from the effects of the present disclosure.

(1) Although the monochrome multifunction peripheral has been described as one example of the image forming apparatus in the embodiments of the present disclosure, the image forming apparatus according to the present disclosure is not limited to the monochrome multifunction peripheral. The image forming apparatus according to the present disclosure may be a color multifunction peripheral.

(2) Although the two-dimensional code has been described as one example of the code in the embodiments of the present disclosure, the code of the present disclosure is not limited to the two-dimensional code. The present disclosure may be realized through a barcode.

(3) The present disclosure may be realized as an image forming method including as steps characteristic constituent means of the image forming apparatus according to the present disclosure, or as a control program including the steps. The program may be distributed via a non-transitory computer-readable medium such as a CD-ROM or a transmission medium such as a communication network.

What is claimed is:

1. An image forming apparatus, comprising:
an acquisition section configured to acquire image data on a cord image representing an identification code containing specific information;
a dividing section configured to divide the image data into first image data representing a first image and second image data representing a second image so that an image to be formed on a recording medium according to the code image is divided into the first image and the second image; and
a data generator configured to generate printing data containing the first image data and the second image data.

2. The image forming apparatus according to claim 1, wherein
the first image is formed on a first side or a second side of the recording medium and the second image is formed on the second side or the first side of the recording medium, and
the data generator generates the printing data containing the first image data representing the first image and the second image data representing the second image.

3. The image forming apparatus according to claim I, further comprising:
an image forming section configured to form an image on the recording medium based on the printing data; and
a controller configured to control the image forming section so that the first image is formed on the first side or the second side of the recording medium based on the first image data and the second image is formed on the second side or the first side of the recording medium based on the second image data.

4. The image forming apparatus according to claim 3, wherein
the printing data contains support line representation data on a support line representation giving support for making the first and second images adjacent to each other, and
the data generator generates the printing data containing the support line representation data.

5. The image forming apparatus according to claim 4, wherein
the printing data contains reference line data on a reference line representing a location where the first and second images are allowed to be made adjacent to each other along the reference line, and fold line data on a fold line representing a location where the recording medium is allowed to be folded along the fold line, and
the data generator generates the printing data containing the reference line data and the fold line data.

6. The image forming apparatus according to claim 5, wherein
the printing data contains fold-back line data on a fold-back line representing a location where the recording medium is allowed to be folded back along the fold-back line, and
the data generator generates the, printing data containing the fold-back line data.

7. The image forming apparatus according to claim 6, wherein
the printing data contains dummy image data on a dummy code giving support for making the first and second images adjacent to each other or obstructing the first and second images being made adjacent to each other, and
the data generator generates the printing data containing the dummy image data.

8. The image forming apparatus according to claim 7, further comprising
a decoding section configured to decode the dummy code, wherein
a value obtained by decoding the dummy code represents at least one of lines that include the reference line, the fold line, and the fold-back line.

9. The image forming apparatus according to claim 2, wherein
the second image is formed on a surface that is different from a surface on which the first image is formed.

10. The image forming apparatus according to claim 2, wherein
the second image is formed on a surface that is the same as a surface on which the first image is formed.

11. An image forming method, comprising:
acquiring image data on a cord image representing an identification code containing specific information;
dividing the image data into first image data representing a first image and second image data representing a second image so that an image to be formed on a recording medium according to the code image is divided into the first image and the second image; and
generating printing data containing the first image data and the second image data.

12. A specific information giving device, comprising:
a specifying section configured to specify specific information;
a code generator configured to generate image data on a code image representing an identification code containing the specific information;
a dividing section configured to divide the image data into first image data representing a first image and second image data representing a second image so that an image to be formed on a recording medium according to the code image is divided into the first image and the second image; and
a data generator configured to generate printing data containing the first image data and the second image data.
